(19) United States
(12) Patent Application Publication
(10) Pub. No.: US 2025/0080502 A1
(43) Pub. Date: Mar. 6, 2025

(54) SYSTEM AND METHOD FOR SECURING NETWORK TRAFFIC USING INTERNET PROTOCOL SECURITY TUNNELS IN A TELECOMMUNICATION NETWORK

(71) Applicant: Rakuten Symphony, Inc., Tokyo (JP)

(72) Inventors: Basawaraj Nadagatti, Bangalore (IN); Deepak Patil, Bangalore (IN); Satish Singh, Bangalore (IN)

(73) Assignee: Rakuten Symphony, Inc., Tokyo (JP)

(21) Appl. No.: 18/024,336

(22) PCT Filed: Dec. 14, 2022
(86) PCT No.: PCT/US2022/052816

§ 371 Date: Mar. 2, 2023

(51) Int. Cl. H04L 9/40; H04W 12/033

(52) U.S. Cl. CPC H04L 63/029; H04L 63/0272; H04W 12/033

(57) ABSTRACT

A base station for securing network traffic using Internet Protocol Security (IPSec) tunnels in a telecommunication network is disclosed. The base station includes a transport manager container that handles network traffic terminations of network interfaces. The base station further includes an internet protocol (IP) security tunnel management container that exchanges one or more IKE parameters between a source IKE daemon unit deployed at the at least one POD and a destination IKE daemon unit deployed at the peer node. Further, the IP security tunnel management container (a) authenticates the peer node based on the extracted IKE parameters, (b) configure the source IKE daemon unit based on the extracted one or more IKE parameters upon successful authentication of the peer node, and (c) create at least one IP security tunnel between the at least one POD and the peer node, based on the updated security data tables in a network kernel.

### FIELD OF INVENTION

The present disclosure is related to telecommunication network systems. More particularly the disclosure relates to a system and method for securing network traffic using internet protocol security (IPsec) tunnels in a telecommunication networks.

### BACKGROUND

Typically, a fifth generation (5G) network introduces a concept of a split or disintegrated Radio Access Network (RAN), where the RAN is separated into: Distributed Units (DU) and Central Units (CU). Typically, the DU does not have any access to customer communications and hence they are suitable to be deployed in unsupervised sites. On the other hand, the CU performs security functions, terminates access stratum (AS) security, and is typically deployed in sites with restricted access to maintenance personnel. Together, the DU and the CU form a gNodeB, (gNB). Communication between the DU and the CU is established using a F1 interface. Moreover, CUs communicate with each other via E1 interface. Traffic transmitted through these interfaces may carry sensitive data and hence is a target for attackers. Thus, the 3GPP specification mandates confidentiality, integrity and replay protection for control plane data exchanged over these interfaces.

In 3GPP security specifications (TS 33.501), requirements for protection of a base station (such as gNB) internal interfaces supporting split architecture are set and further security mechanisms are detailed for both F1 and E1 interfaces. In both cases, support of an Internet Protocol Security (IPsec) tunnel is mandated. Concrete implementation specifying that the IPsec ESP protocol according to IETF RFC 4303 as profiled by TS 33.21089 and IKEv2 certificate-based authentication (according to profile described by TS 33.31090) shall be used. Observing at the potential optionality/flexibility defined in this specification, there is a difference between control and user plane data. The clause 5.3.9 sets the requirements for confidentiality, integrity and replay protection as mandatory for the control plane interface (F1-C). However, when it comes to the user plane (F1-U) interface, the situation is different. Although there is a requirement stating that the gNB shall support confidentiality, integrity and replay protection on the gNB DU-CU F1-U interface for user plane, there is also a note which states that the above requirements allow to have F1-U protected differently (including turning integrity and/or encryption off or on for F1-U) from all other traffic on the CU-DU (e.g., the traffic over F1-C). Regarding the E1 interface protection, used for signalling data transfer, the requirement states that the E1 interface between CU-CP and CU-UP shall be confidentiality, integrity and replay protected without explicitly listing any further remarks or exclusions. In view of this, it is evident that the specification requires mandatory confidentiality, integrity and replay protection for the F1 signalling plane and for the E1 interface, while leaving it optional for the F1 user plane interface.

Data transmitted through RAN interfaces may include sensitive data, both on user and control data plane and its protection is essential to prevent information disclosure, data tampering or denial of service attacks. Further, the DU-CU split allows flexibility in deployment options, however relies on appropriate securing of the interface between the DU and the CU, which otherwise leaves the sensitive data vulnerable to attacks.

Therefore, the need exists for a method and/or apparatus to secure network traffic using Internet Protocol Security (IPsec) tunnels in a telecommunication network to address the above-mentioned deficiencies. Specifically, a need exists to create and manage IPsec channels for 3GPP F1/E1/X2/N2/N3/S1 interfaces in a cloud native radio access network (RAN).

### SUMMARY

In accordance with one embodiment of the disclosure, a base station for securing network traffic using Internet Protocol Security (IPsec) tunnels in a telecommunication network is disclosed. The base station includes one or more hardware processors, and a memory. The memory is coupled to the one or more hardware processors. The memory includes a plurality of Programmable, Open, and Disaggregated Solution (POD) subsystems in a form of microservice based containers executable by the one or more hardware processors. Each of the plurality of POD subsystems includes a transport manager container, and an internet protocol (IP) security tunnel management container.

The transport manager container is configured to handle network traffic terminations of one or more network interfaces. The one or more network interfaces includes at least one of: a control path interface and data path interface.

The IP security tunnel management container is configured to receive Internet Key Exchange (IKE) day−1 local configuration for each transport manager container in each of the plurality of POD subsystems. Further, the IP security tunnel management container is configured to negotiate IP security (IPsec) policies with a peer node over an ISAKMP protocol according to the received IKE day−1 local configuration.

The IP security tunnel management container is configured to receive one or more network packets from the peer node via the one or more network interfaces. The peer node is communicatively connected to at least one POD subsystem of the plurality of POD subsystems of the base station.

The IP security tunnel management container is configured to extract one or more IKE parameters for a predefined configuration time interval from the received one or more network packets. The one or more IKE parameters are exchanged between a source IKE daemon unit deployed at the at least one POD and a destination IKE daemon unit deployed at the peer node. The one or more IKE parameters comprise an IP address of the peer node, one or more ciphering algorithms, security policy details, and a peer node certificate identifier.

The IP security tunnel management container is configured to authenticate the peer node based on the extracted one or more IKE parameters.

The IP security tunnel management container is further configured to configure the source IKE daemon unit based on the extracted one or more IKE parameters upon successful authentication of the peer node.

The IP security tunnel management container is configured to further update one or more security data tables in a network kernel with a set of information upon configuring the source IKE daemon unit. The set of information includes at least one of: information associated with ciphering algorithms, one or more secret keys, one or more security policies, and information on security parameter indexes (SPI). The IP security tunnel management container is further configured to create at least one IP security tunnel between the at least one POD and the peer node, based on the updated one or more security data tables in the network kernel. The IP security tunnel management container is further configured to perform one or more secure operations through the created at least one IP security tunnel. The one or more secure operations includes at least one of: an encryption and a decryption of the received one or more network packets.

In an aspect of the embodiment, the IP security tunnel management container is further configured to monitor the created at least one IP security tunnel to determine one or more states of the created at least one IP security tunnel. Further, the IP security tunnel management container is configured to auto-restore the created at least one IP security tunnel based on the determined one or more states.

In another aspect of the embodiment, the IP security tunnel management container is further configured to generate one or more alarm events corresponding to one or more northbound entities based on the determined one or more states.

In another aspect of the embodiment, the transport manager container and the IP security tunnel management container are deployed in a user plane of the base station.

In yet another aspect of the embodiment, the base station further comprises a fast path terminating unit configured to register information related to security association database (SAD) and security policy database (SPD) from the network kernel using a network link socket. The information related to the SAD and SPD are updated by the source IKE daemon unit when the at least one IP security tunnel is created based on one or more internet key exchange (IKE) messages exchanged with the destination IKE daemon unit.

In yet another aspect of the embodiment, the IP security tunnel management container is further configured to perform at least one of: enabling and disabling of the created at least one IP security tunnel based on type of network interfaces.

In an aspect of the embodiment, in authenticating the peer node based on the extracted one or more IKE parameters, the IP security tunnel management container is configured to retrieve device certificate information of the peer node from the extracted IKE parameters. Further, the IP security tunnel management container is configured to authenticate the peer node based on the retrieved device certificate information.

In yet another aspect of the embodiment, the IP security tunnel management container is configured to interact with one or more peer subsystems deployed across plurality of peer nodes for securing the network traffic within the telecommunication network.

In a further aspect of the embodiment, the base station further comprises a Centralized Unit Control Plane (CU-CP), a Centralized Unit User Plane (CU-UP) communicatively coupled to the CU-CP; and a Distributed Unit (DU) communicatively coupled to the CU-CP and the CU-UP. Each of the CU-CP, the CU-UP, and the DU comprises the plurality of POD subsystems.

In an aspect of the embodiment, a method for securing network traffic using Internet Protocol Security (IPsec) tunnels in a telecommunication network is disclosed. The method includes receiving Internet Key Exchange (IKE) day−1 local configuration for a transport manager container in each of a plurality of Programmable, Open, and Disaggregated Solution (POD) subsystems of a base station. Further, the method includes negotiating IPsec policies between at least one POD of the plurality of POD subsystems and a peer node over an ISAKMP protocol according to the received IKE day−1 local configuration, Furthermore, the method includes receiving one or more network packets from the peer node via one or more network interfaces. Moreover, the method includes extracting one or more internet key exchange (IKE) parameters for a predefined configuration time interval from the received one or more network packets. The one or more IKE parameters comprise an internet protocol (IP) address of the peer node, one or more ciphering algorithms, security policy details, and a peer node certificate identifier.

Further, the method includes exchanging the one or more IKE parameters between a source IKE daemon unit deployed at the base station and a destination IKE daemon unit deployed at the peer node, Also, the method includes authenticating, the peer node based on the extracted one or more IKE parameters. Furthermore, the method includes configuring the source IKE daemon unit based on the extracted one or more IKE parameters upon successful authentication of the peer node. Furthermore, the method includes (h) updating, one or more security data tables in a network kernel with a set of information upon configuring the source IKE daemon unit. Furthermore, the method includes creating at least one IP security tunnel between the at least one POD subsystem and the peer node, based on the updated one or more security data tables in the network kernel. Additionally, the method includes performing one or more secure operations through the created at least one IP security tunnel.

In an aspect of the embodiment, the method further comprises monitoring the created at least one IP security tunnel to determine one or more states of the created at least one IP security tunnel. The method further comprises auto restoring the created at least one IP security tunnel based on the determined one or more states.

In another aspect of the embodiment, the method further comprises generating one or more alarm events corresponding to one or more northbound entities based on the determined one or more states.

In another aspect of the embodiment, the method further comprises registering information related to security association database (SAD) and security policy database (SPD) from the network kernel using a network link socket. The information related to the SAD and SPD are updated by the source IKE daemon unit when the at least one IP security tunnel is created based on one or more internet key exchange (IKE) messages exchanged with the destination IKE daemon unit.

In another aspect of the embodiment, the method further comprises performing at least one of: enabling and disabling of the created at least one IP security tunnel based on type of network interfaces.

In another aspect of the embodiment, in authenticating the peer node based on the extracted one or more IKE parameters, the method comprises retrieving device certificate information of the peer node from the extracted IKE parameters and authenticating the peer node based on the retrieved device certificate information.

In another aspect of the embodiment, the method further comprises interacting with one or more peer subsystems deployed across plurality of peer nodes for securing the network traffic within the telecommunication network.

In another aspect, disclosed is a non-transitory computer-readable storage medium having instructions stored therein that when executed by a hardware processor, cause the processor to execute operations of: (a) receiving Internet Key Exchange (IKE) day−1 local configuration for a transport manager container in each of a plurality of Programmable, Open, and Disaggregated Solution (POD) subsystems of a base station; (b) negotiating IPsec policies between at least one POD of the plurality of POD subsystems and a peer node over an ISAKMP protocol according to the received IKE day−1 local configuration, (c) receiving one or more network packets from the peer node via one or more network interfaces; (d) extracting one or more internet key exchange (IKE) parameters for a predefined configuration time interval from the received one or more network packets; (e) exchanging the one or more IKE parameters between a source IKE daemon unit deployed at the base station and a destination IKE daemon unit deployed at the peer node; (f) authenticating the peer node based on the extracted one or more IKE parameters; (g) configuring the source IKE daemon unit based on the extracted one or more IKE parameters upon successful authentication of the peer node; (h) updating one or more security data tables in a network kernel with a set of information upon configuring the source IKE daemon unit; (i) creating at least one IP security tunnel between the at least one POD subsystem and the peer node, based on the updated one or more security data tables in the network kernel; and (j) performing one or more secure operations through the created at least one IP security tunnel.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a third-generation partnership project (3GPP) interfaces with plain traffic towards a peer node, in accordance with prior art;

FIG. 2 is a schematic representation of a cloud native network architecture depicting 5^{th} Generation (5G) New Radio (NR) with a plurality of interfaces, in accordance with an embodiment of the present disclosure;

FIG. 3 is a block diagram illustrating an exemplary base station for securing the network traffic using internet protocol (IP) security tunnels in a telecommunication network, in accordance with an embodiment of the present disclosure;

FIG. 4 is a schematic representation of 3GPP interfaces with secured network traffic using an IP security tunnel between the plurality of POD subsystems and a peer node, in accordance with an embodiment of the present disclosure;

FIG. 5 is a block diagram depicting a peer-to-peer communication network for creation of the IP security tunnel and crypto operations for application data, in accordance with an embodiment of the present disclosure;

FIG. 6 is a block diagram depicting creation of the IP security tunnel for fast path applications, in accordance with an embodiment of the present disclosure; and

FIG. 7 is a flowchart illustrating a computer implemented method for securing the network traffic using the IP security tunnels in the telecommunication network, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

To promote an understanding of the principles of the disclosure, reference will now be made to embodiments illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprise,” “comprises,” “comprising,” or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following description, reference will be made to a number of terms, which shall be defined to have the following meanings. The singular forms “a,” “an,” and “the” include plural references unless the context clearly dictates otherwise.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Radio Node: The term “radio node” is used to refer either a radio access node or a wireless device.

Radio Access Node: The term a “radio access node” or “radio network node” refers to any node in a radio access network which operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and the like.

Core Network Node: The term a “core network node” refers to any type of node in a core network.

Wireless Device: The term a “wireless device” refers to any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device or the like.

Network Node: The term a “network node” refers any node that is either part of the radio access network or the core network of a cellular communications network/system.

Embodiments described herein may be exploited in any wireless communication networks, such as, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Z-Wave, Zigbee and other 802.XX wireless technologies and/or legacy telecommunication technologies.

C-RAN (cloud radio access network) is a centralized, cloud computing-based architecture for radio access networks (RAN) which enables large-scale deployment, collaborative radio technology support, and real-time virtualization capabilities. The C-RAN is an evolution of current wireless communication system and uses latest common public radio interface (CPRI) standard, coarse or dense wavelength division multiplexing (CWDM/DWDM) technology and millimeter wave (MM wave) transmission for long distance signals. The “C” in C-RAN may alternatively stand for centralized or collaborative. A radio access network (RAN) acts as a bridge connecting cellular devices to a public or a private cloud. Mobile devices send information via radio waves to the RAN baseband units which further forward data to a core network that accesses global internet.

The C-RANs enhance radio networks through improvements in real-time virtualization and cloud computing to provide higher spectrum efficiency, faster RAN speeds, and support a larger number of mobile devices.

A cloud native 5G core network refers to a core network that is container based and micro services oriented. The cloud native 5G core network decomposes software into smaller, more manageable pieces. Service providers are defining and deploying a cloud-native infrastructure across entire network from the core to far edge. As defined by the 3rd Generation Partnership Project (3GPP), a Service-Based Architecture (SBA) is a set of interconnected network functions (NFs) that deliver control plane functionality and common data repositories of the cloud native 5G core network. In other words, the Service Based Architecture (SBA) provides modular building blocks (both Control Plane and User Plane) modelled as the Network Functions (NFs) which invoke and use each other's services. Supporting the SBA brings new requirements for control, coordination, and orchestration of disaggregated network functions that are distributed across the core network. The network functions are containerized microservices which can support the 5G Core, virtualized radio access network (vRAN), and N6-LAN network functions.

In an embodiment, a EUTRAN network usually includes a plurality of eNodeBs, also known as cell sites. The eNodeBs provides radio functions and performs key control functions including scheduling of air link resources or radio resource management, active mode mobility or handover, and admission control for services. The eNodeBs are responsible for selecting which mobility management entities will serve a user equipment (UE) and for protocol features such as header compression and encryption. The eNodeBs that make up the EUTRAN collaborate with one another for radio resource management and handover.

Communication between the user equipment and the eNodeB occurs via an air interface (also known as “LTE-Uu” interface).

In an embodiment, the terms “eNodeB” and “eNB” are used alternatively throughout the specification. Further, the terms “gNodeB” and “gNB” are used alternatively throughout the specification. Furthermore, the terms “IPSec” and “IP Security Tunnel” or “IPsec tunnel” are used alternatively throughout the specification.

Multiple eNodeBs may be interconnected with one another using an X2 interface. The X2 interface may be established between two eNodeBs to provide an exchange of signals, which may include a load-related information or interference-related information as well as handover-related information. The eNodeBs communicate with an evolved packet core via an S1 interface. The S1 interface may be split into two interfaces: one for the control plane and the other for the user plane.

In an embodiment, according to the 3GPP specification, the air interface for LTE, as well as for 5G New Radio (NR), is called as the ‘Uu interface’. The NR air interface is either referred to as NR-Uu or only NR. The LTE air interface is correspondingly named LTE-Uu. The UE establishes connections to the eNodeB that acts as a master node and to a gNodeB that acts as a secondary node. The eNodeB is connected to an ePC via the S1 interface and to the en-gNodeB via the X2 interface. The S1 interface consists of S1-MME for the control plane, while the S1AP is an application layer signalling protocol. S1-MME, also known as S1-C, is a reference point for the control plane protocol between E-UTRAN and a mobility Management Entity (MME). The S1-MME uses a SCTP protocol stack for SIAP control plane transport. A SCTP signalling associations are automatically set up at eNodeB start-up. For each MME, the eNodeB initializes an SCTP association as described in IETF RFC4960 using an OAM configured initial remote IP endpoint as the starting point until SCTP connectivity is established. The eNodeB may be connected to several MMEs over the S1 flex protocol. In S1 flex configuration, a NAS node selection algorithm selects an appropriate MME based on various possible inputs. In 5G NR, any connectivity between two eNodeBs as well as between en-gNodeB and eNodeB is still called the X2 interface. According to TS38.420, a Xn interface describes an interface between two gNodeBs in a standalone (SA) architecture. Hence, it is not applicable in E-UTRA-NR Dual Connectivity (EN-DC). Some Operators enable the X2 interface to support intra-LTE active mode mobility. For security reasons, the X2 interface might need to be ciphered, which means IPsec tunnels will be used. In general, two possible IPsec configurations for the X2 interface are possible. The first one is a direct X2 connection from eNodeB directly to neighbour eNodeB. In this configuration, the eNodeB needs to support IPsec tunnels for each neighbouring eNodeB. In indirect X2 connections over IPsec gateway, the X2 interface traffic will be included in the existing IPsec tunnels between the eNodeB and the IPsec gateway. The longer transfer delay on the X2 interface in this configuration has no significant impact.

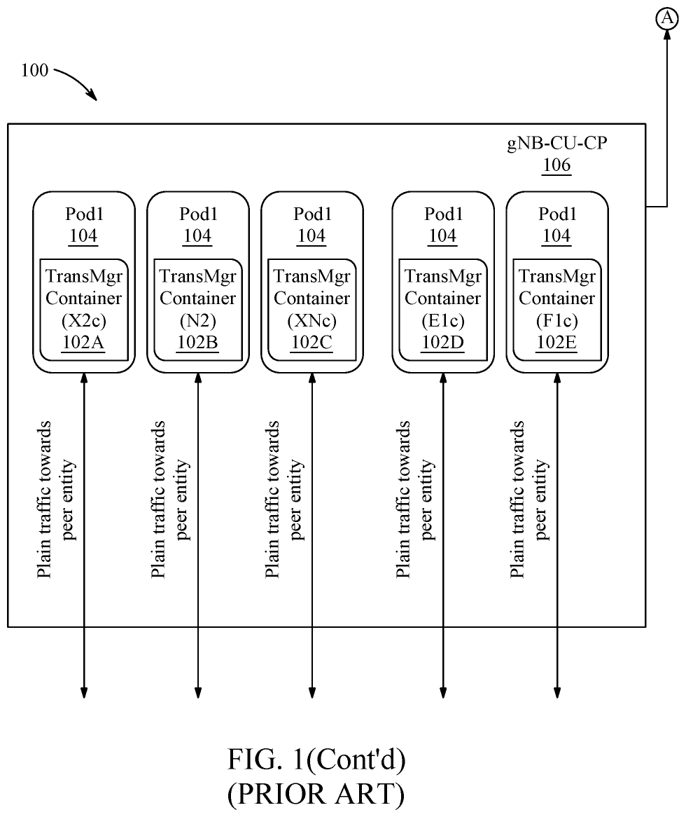

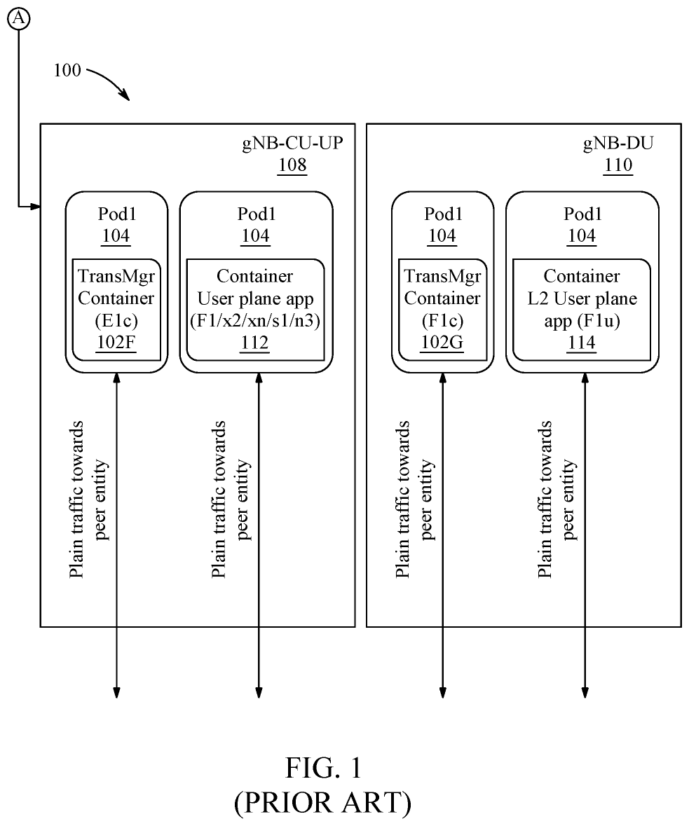

FIG. 1 illustrates a schematic representation of third generation partnership projects (3GPP) interfaces with plain traffic towards a peer node, in accordance with prior art. FIG. 1 shows that cloud native random access network (RAN) or gNB microservice architecture 100 for different 3GPP interfaces including F1 interface, E1 interface, X2 interface, N2 interface, N3 interface, and S1 interface terminating in different Programmable, Open, and Disaggregated Solution (PODs) 104 of network functions. In an embodiment, a base station may include a centralized Unit Control Plane (CU-CP) 106, a Centralized Unit User Plane (CU-UP) 108 that is communicatively coupled to the CU-CP 106, and a Distributed Unit (DU) 110 that is communicatively coupled to the CU-CP 106 and the CU-UP 108. Each of the CU-CP 106, the CU-UP 108, and the DU 110 includes the plurality of POD subsystems 104.

In each of these PODs 104, respective transport manager container 102A-G is handling the terminating operations. Though, the transport manager container 102A-G controls traffic terminations, there is no common service to secure the traffic terminations for each of the above said gNB 3GPP interfaces.

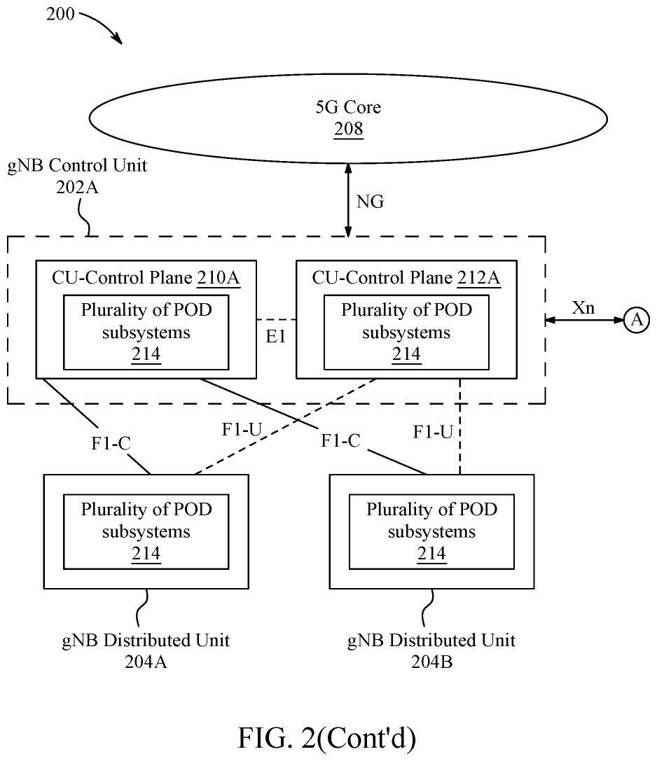

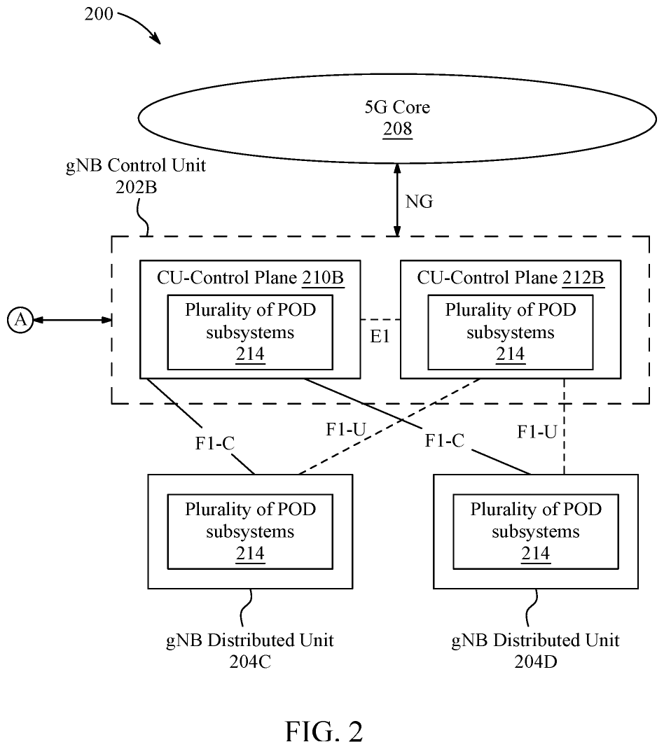

Referring now to the drawings, and more particularly to FIGS. 2 through 7, where similar reference characters denote corresponding features consistently throughout the figures, there are shown example embodiments and these embodiments are described in the context of the following exemplary system and/or method.

FIG. 2 is a schematic representation of a cloud native network architecture 200 depicting 5th Generation (5G) New Radio (NR) with a plurality of interfaces, in accordance with an embodiment of the present disclosure. In a preferred embodiment, a fifth-generation mobile communication system is also referred to herein as 5G System or Next Generation (NextGen) System (NG System). The new radio access technology (RAT) for 5G System is called New Radio (NR), 5G RAT, or NG RAT. The new Radio Access Network (RAN) for the 5G System is called 5G-RAN or NextGen RAN (NG RAN). New base stations in 5G-RAN are called NR NodeB (NR NB) or gNodeB (gNB).

The new core network for 5G System is called 5G Core Network 208 (5G-CN or 5GC) or NextGen Core (NG Core). A wireless terminal (User Equipment (UE)) that connects to the 5G System is called 5G UE, NextGen UE (NG UE), or simply UE.

The 5G system is expected to operate in two modes including non-standalone operation mode and a standalone operation mode. For non-standalone operation mode, the 3GPP specification defined the extensions for S1 and X2 interfaces and for standalone operations new interfaces are defined. The new interfaces for the standalone operation may be at least one of: an Interface between RAN Node as X2/Xn, an Interface between RAN and Core Network as S1/NG, an Interface for Function Split and Open Interface as F1/E1 within RAN Node, an Interface between physical (PHY) and Radio as enhanced common public radio interface (eCPRI), and the like.

A network node (or radio network node) is used herein to refer to any type of network node serving the UE and/or connected to other network node, network element, or another network node from which the UE can receive a radio signal. The network node also has multiple antennas for performing various transmission operations (e.g., MIMO operations). The network node has a cabinet and protected enclosures, an antenna mast, and actual antennas. The network node serves several cells, also called sectors, depending on the configuration and type of antenna.

Examples of network nodes includes, but are not limited to, NodeB devices, base station (BS) devices, access point (AP) devices, radio access network (RAN) devices and the like. The network node may also comprise multi-standard radio (MSR) radio node devices, including but not limited to an MSR BS, an eNode B, a network controller, a radio network controller (RNC), a base station controller (BSC), a relay, a donor node controlling relay, a base transceiver station (BTS), a transmission point, a transmission node, an RRU, an RRH, nodes in distributed antenna system (DAS), and the like. In 5G terminology, the network node may be referred to as a gNodeB device.

The Interface between a RAN Node as X2/Xn: The X2 interface is used between eNBs in LTE is reused between RAN nodes in the non-standalone operation (between eNB and en-gNB), and a Xn interface is newly specified between RAN nodes in a standalone operation (between ng-eNB and ng-eNB/gNB and gNB/ng-eNB and gNB). The extensions of X2 interface include functions adopting the EN-DC and flow control for split bearers for the non-standalone operation. The flow control function, which is defined for LTE-DC split bearers is used for appropriately split downlink data when using the radio resources of multiple RAN nodes. Although functions and interfaces for basic flow control are specified for LTE-DC, the information exchanged between the RAN nodes is further enhanced to optimize the flow control for the non-standalone operation. Although Xn interface is based on X2 interface's function, the UE context management function is chiefly enhanced for adopting new QoS flow framework and network slice.

The Interface between RAN and Core Network as S1/NG: Similar to interface between the RAN nodes, the interfaces between RAN nodes and the 5G Core network 208 also differ for the non-standalone and the standalone operation modes. In the non-standalone operation, the S1 interface is reused for between the RAN node and EPC. On the other hand, a new interface with name NG is specified between the RAN nodes (ng-eNB/gNB and 5GCs in the standalone operation.

The extensions of S1 interface include a function that reports data volume for a specific RAT in the non-standalone operation. This function is introduced for calculating amount of data volume via NR. In the non-standalone operation, since the S1-C interface is only established between a Master Node and the 5G Core Network 208, the data volume through the Master Node terminated bearers is counted by the Master Node itself and reported directly to the 5G Core Network 208 via the S1 interface, while the data volume from a Secondary Node terminated bearers is counted by a Secondary Node and reported to the Master Node via the X2 interface, and then reported by the Master Node to the Core Node via the S1 interface.

The Interface for Function Split and Open Interface as F1/E1 within RAN Nodes: To address an issue of explosive increases of bandwidth required for transport between the Centralized Unit (CU) 202 and Distributed Unit (DU) 204 by introduction of massive multi input multi output (MIMO) and extending frequency bandwidth using Cloud RAN (C-RAN) deployment, a new functional split between the CU (gNB-CU) 202 and the DU (gNB-DU) 204 within the gNB and the corresponding open interface between these nodes are defined. Specifically, a functional split is adopted where a PDCP layer and above may be located in the gNB-CU 202, and a RLC layer and below may be located in the gNB-DU 204. The standard interface between them is specified as F1 interface.

In addition to a functional split between gNB-CU 202 and gNB-DU 204, the functional split of control plane (C-plane) and a user plane (U-plane) in the gNB-CU 202 has been introduced.

Additionally, in 3GPP standardization, an open interface between the C-plane termination parts and U-plane termination parts of gNB-CU 202 are specified such that this sort of functional separation is achieved even between different vendors. The network node that terminates the C-plane 210A of gNB-CU 202 is called gNB-CU-CP 210A, and the network node that terminates the U-plane 212B of the gNB-CU 202 is called gNB-CU-UP 212B. The standard interface between these network nodes may be specified as E1 interface.

In an embodiment, typically gNB network functions (gNB-CUCP, gNB-CUUP, gNB-DU) are implemented as microservice architecture. In the present disclosure, each of the 3GPP interfaces (F1/E1/X2/N2/N3/S1) of gNB traffic is terminated in different PODs of the network functions. There exists no common solution or model today to create and manage the IPsec tunnels for these PODs to secure traffic for the above-mentioned interfaces.

The gNB (also referred as “base station” throughout the specification) for securing network traffic using Internet Protocol Security (IPsec) tunnels is disclosed. The gNB comprises a plurality of POD subsystems 214 capable of securing network traffic using Internet Protocol Security (IPsec) tunnels. The plurality of POD subsystems 214 are deployed in gNB network functions, such as gNB-CUCP 210A-B, gNB-CUUP 212A-B, and gNB-DU 204. In an embodiment, each of the 3GPP interfaces (F1/E1/X2/N2/N3/S1) of gNB traffic is terminated in the plurality of POD subsystems 214 of the network functions.

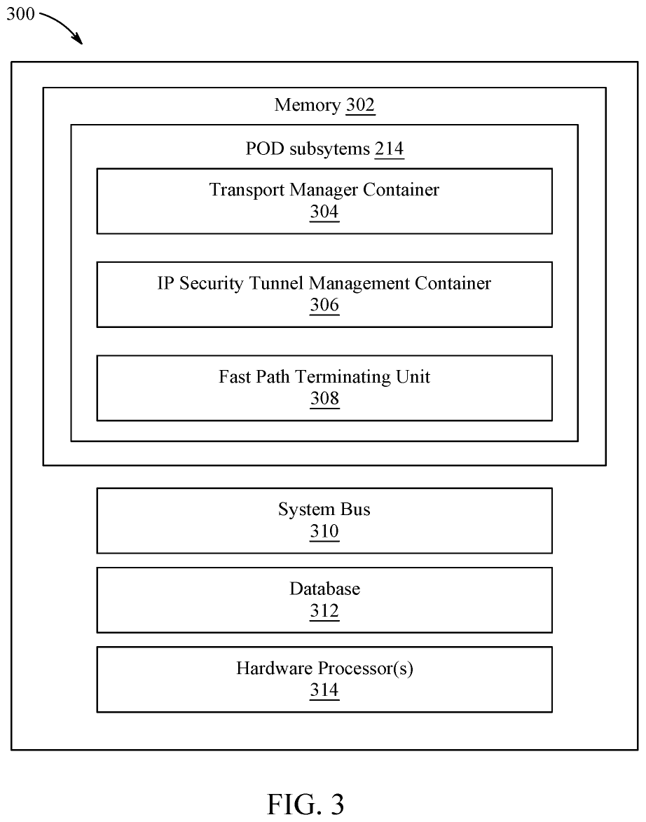

The gNB comprises one or more hardware processors and a memory coupled to the one or more hardware processors. The memory comprises a plurality of Programmable, Open, and Disaggregated Solution (POD) subsystems 214 in a form of microservice based containers executable by the one or more hardware processors. The plurality of POD subsystems 214 includes a transport manager container configured to handle network traffic terminations of one or more network interfaces. The one or more network interfaces comprises at least one of a control path interface and data path interface. The plurality of POD subsystems 214 further includes an internet protocol (IP) security tunnel management container communicatively coupled to the transport manager container. The IP security tunnel management container is configured to receive Internet Key Exchange (IKE) day−1 local configuration for each transport manager container in each of the plurality of POD subsystems 214. Further, the IP security tunnel management container is configured to negotiate IPsec policies with a peer node over an ISAKMP protocol according to the received IKE day−1 local configuration. Furthermore, the IP security tunnel management container is configured to receive one or more network packets from the peer node via the one or more network interfaces. The peer node comprises peer POD subsystems which is communicatively connected to at least one POD subsystem 214 of the plurality of POD subsystems 214 of the base station. Also, the IP security tunnel management container is configured to extract one or more (IKE) parameters for a predefined configuration time interval from the received one or more network packets. The one or more IKE parameters are exchanged between a source IKE daemon unit deployed at the at least one POD and a destination IKE daemon unit deployed at the peer node. Furthermore, the IP security tunnel management container is configured to authenticate the peer node based on the extracted one or more IKE parameters. Also, the IP security tunnel management container is configured to configure the source IKE daemon unit based on the extracted one or more IKE parameters upon successful authentication of the peer node. Further, the IP security tunnel management container is configured to update one or more security data tables in a network kernel with a set of information upon configuring the source IKE daemon unit. The set of information comprises at least one of information associated with ciphering algorithms, one or more secret keys, one or more security policies, and information on a security parameter indexes (SPI). Additionally, the IP security tunnel management container is configured to create at least one IP security tunnel between the at least one POD and the peer node, based on the updated one or more security data tables in the network kernel. Moreover, the IP security tunnel management container is configured to perform one or more secure operations through the created at least one IP security tunnel. The one or more secure operations comprises at least one of encryption and decryption of the received one or more network packets. A detailed view of the gNB is shown in FIG. 3.

The cloud native network architecture 200 as depicted in FIG. 2 may further include a cloud interface, a server including hardware assets and an operating system (OS), a network interface, and application program interfaces (APIs). The cloud interface enables communication between the gNB and a UE. Also, the cloud interface enables communication between the gNodeB and other components such as 5G core 208, other POD systems of a peer network node and the like. As used herein, “cloud native network architecture 200” refers to a processing environment comprising configurable computing physical and logical assets, for example, networks, servers, storage, applications, services, etc., and data distributed over the cloud platform. The cloud native network architecture 200 provides on-demand network access to a shared pool of the configurable computing physical and logical assets.

Those of ordinary skilled in the art will appreciate that the hardware depicted in FIG. 2 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of the base station suitable for use with the present disclosure is not being depicted or described herein. Instead, only so much of cloud native network architecture 200 as is unique to the present disclosure or necessary for an understanding of the present disclosure is depicted and described. The remainder of the construction and operation of the cloud native network architecture 200 may conform to any of the various current implementation and practices known in the art.

Although the components of the FIG. 2 depict a gNodeB and the respective network functions, those ordinarily skilled in the art may imply that the cloud native network architecture 200 may be applicable to other radio access nodes such as, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), 6G, Internet of Things (IoT), narrow band (NB IoT), Open RAN, and the like and a combination thereof. Further, the cloud native network architecture 200 may also be applicable to cloud based non-RAN technology PODs.

FIG. 3 is a block diagram illustrating an exemplary base station 300 for securing the network traffic using internet protocol (IP) security tunnels in a telecommunication network, in accordance with an embodiment of the present disclosure. The base station 300 (also referred herein as gNodeB (gNB)) is configured to secure network traffic (such as for example, Egress/Ingress) for 3GPP interfaces using internet protocol (IP) security tunnels. In a preferred embodiment, an IPsec tunnel creation and management functionality are integrated with each of the plurality of POD subsystems as a side car service.

The base station 300 includes a hardware processor 314. The base station 300 further includes a memory 302 coupled to the hardware processor 314. The memory 302 includes a plurality of Programmable, Open, and Disaggregated Solution (POD) subsystems 214 in a form of microservice based containers executable by the hardware processor 314. The plurality of POD subsystems 214 includes one or more containers that are deployed on a single network node. The microservice based containers comprises one or more containerized applications which may be used to facilitate a serverless, cloud native computing deployment and management model for software applications. In support of a serverless, cloud native computing deployment and management model for software applications, such microservice based containers may be used as part of an event handling mechanisms such that various events cause a containerized application to be spun up to operate as an event handler. The systems described above may be deployed in a variety of ways, including being deployed in ways that support fifth generation (‘5G’) networks.

The plurality of POD subsystems 214 may help to manage groups of closely related microservice containers that may depend on each other and that may need to cooperate on the same host to accomplish their tasks. The plurality of POD subsystems 214 can be scheduled together and run on a same physical server or a virtual machine. The microservice containers in each of the plurality of POD subsystems 214 may have the same IP address and port space and they may communicate via localhost or standard inter-process communication.

The hardware processor(s) 314, as used herein means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 314 may also include embedded controllers, such as generic or programmable logic devices or arrays, application specific integrated circuits, single-chip computers, and the like.

The memory 302 may be non-transitory volatile memory and non-volatile memory. The memory 302 may be coupled for communication with the processor(s) 314, such as being a computer-readable storage medium. The processor(s) 314 may execute machine-readable instructions and/or source code stored in the memory 302. A variety of machine-readable instructions may be stored in and accessed from the memory 302. The memory 302 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 302 includes a plurality of subsystems stored in the form of machine-readable instructions on any of the above-mentioned storage media and may be in communication with and executed by the processor(s) 314.

The memory 302 includes the plurality of POD subsystems 214 stored in the form of executable program which instructs the hardware processor 314 via a system bus 310 to perform the above-mentioned method steps. The plurality of POD subsystems 214 include following microservice based containers: a transport manager container 304, an internet protocol (IP) security tunnel management container 306, and a fast path terminating unit 308. Each of the transport manager container 304, the internet protocol (IP) security tunnel management container 306, and the fast path terminating unit are microservice based containers.

Containerization may include an operating system feature in which the network kernel allows the existence of multiple isolated user-space instances. Such instances, called containers, partitions, virtual environments, and the like, may operate similar to real computers from the point of view of programs running in the instances. A computer program running on an ordinary operating system can see the resources (connected devices, files and folders, network shares, processing power, quantifiable hardware capabilities, and the like) of that computer. However, programs running inside a container may only see the container's contents and devices assigned to the container.

Containers may refer to forms of virtualization at operating system level. Containers may represent an emerging VNF option that allows networks to run more VNFs on a single physical host server. Containers may not include their own operating system but may depend more heavily on host OS. Containers may encapsulate application dependencies, required libraries, and configuration in a package which is isolated from other containers in the same operating system. Further, VNF microservices may be deployed in containers which enable the continuous delivery and deployment of larger and more complex applications.

Containers may be used along with virtual machines in NFV environments. The deployment of VNFs may be virtual machine only, containers only, or hybrid. In the hybrid mode, the container may run in VMs providing security and isolation features. The containers may also be run in a heterogeneous mode where some of VNFs will run in VM, some in containers and mix of both. Having a container in place to host microservices may allow active schedule and management to optimize resource utilization. A container orchestration engine may enable the provisioning of hosts resources to containers, the assignment of containers to hosts, and the instantiation and rescheduling of containers.

Containerized microservices may have the ability to orchestrate the containers so that separate lifecycle management processes may be applied to each service. This allows for each service to be versioned and upgraded singularly as opposed to upgrading the entire VNF in VM. For example, while upgrading a whole application or VNF, a container scheduler may determine which individual services have changed and deploys only those specific services. The VM may instantiate a container by maintaining state information regarding the containers and pods, related IP and MAC information, and node information.

Computer memory elements may include any suitable memory device(s) for storing data and executable program, such as read only memory, random access memory, erasable programmable read only memory, electronically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the hardware processor(s) 314.

The transport manager container 304 is communicatively connected to the hardware processor 314. The transport manager container 304 is configured to handle network traffic terminations of one or more network interfaces. In an embodiment, one or more network interfaces include at least one of: a control path interface and data path interface. The control path interface between 5G core network 208 and gNB 300 (i.e., RAN) is called N2 interface, NG2 interface or NG-c interface and is used for transfer of Non-Access Stratum (NAS) information and control between the 5G core network 208 and the gNB 300 for information (e.g., N2 AP Information Element). The user/data path interface between the 5G core network 208 and the gNB 300 (i.e., RAN) is called a N3 interface, NG3 interface or NG-u interface and includes packets of one or more PDU flows within the UE's PDU session. Further, the N3 interface is a user path interface between the 5G core network 208 and the gNB 300 (i.e., NG-RAN).

The IP security tunnel management container 306 is communicatively connected to the hardware processor 314. The IP security tunnel management container 306 is configured to receive Internet Key Exchange (IKE) day−1 local configuration for each transport manager container 304 in each of the plurality of POD subsystems 214. The IP security tunnel management container 306 is further configured to negotiate IP security (IPsec) policies with a peer node over an internet security association and key management protocol (ISAKMP) according to the received IKE day−1 local configuration. The IP security tunnel management container 306 is further configured to receive one or more network packets from the peer node via the one or more network interfaces. In an embodiment, the peer node is communicatively connected to at least one POD subsystem of the plurality of POD subsystems 214 of the base station 300. In an exemplary embodiment, the peer node may be another random-access network. In another exemplary embodiment, the peer node may be another POD subsystem itself.

The IP security tunnel management container 306 is further configured to extract one or more internet key exchange (IKE) parameters for a predefined configuration time interval from the received one or more network packets. The predefined configuration time interval may be day−1 configuration. In an embodiment, the one or more IKE parameters are exchanged between a source IKE daemon unit deployed at the at least one POD and a destination IKE daemon unit deployed at the peer node. In an embodiment, the one or more IKE parameters include at least one of: an IP address of the peer node, one or more ciphering algorithms, security policy details, a peer node certificate identifier, and the like. Upon extracting the one or more IKE parameters, the IP security tunnel management container 306 is further configured to is configured to download or renew a X.509 device certificate needed for end entity authentication as part the IPsec tunnel creation procedure. In an embodiment, the X. 509 certificate is a widely used digital certificate format based on asymmetric cryptography. Each certificate uses a pair of encryption keys known as the public and private key. The private key on a certificate may generate encryption that can only be decrypted by its public key partner.

The IP security tunnel management container 306 is further configured to authenticate the peer node based on the extracted one or more IKE parameters. The IP security tunnel management container 306 is also configured to authenticate the peer node based on the extracted one or more IKE parameters by (a) retrieving device certificate information of the peer node from the extracted IKE parameters, and (b) authenticating the peer node based on the retrieved device certificate information. In an embodiment, in order to authenticate the peer node, the IP security tunnel management container 306 is further configured to update Security association database (SAD) and Security policy database (SPD) tables in the network kernel with the corresponding ciphering/authentication algorithms, secrete keys, policies, SPI details and the like. The SAD/SPD information is needed to encrypt/decrypt the application data.

Further, the IP security tunnel management container 306 is configured to configure the source IKE daemon unit based on the extracted one or more IKE parameters upon successful authentication of the peer node.

The IP security tunnel management container 306 is also configured to update one or more security data tables in a network kernel with a set of information upon configuring the source IKE daemon unit. In an embodiment, the set of information includes at least one of: information associated with ciphering algorithms, one or more secret keys, one or more security policies, information on security parameter indexes (SPI), and the like. The IP security tunnel management container 306 is further configured to create at least one IP security tunnel between the at least one POD and the peer node, based on the updated one or more security data tables in the network kernel. In an embodiment, the at least one IP security tunnel is created according to RFC 7296 (i.e., the Internet Key Exchange Protocol Version 2 (IKEv2)). In an embodiment, the aim of the Internet Key Exchange (IKE) is to generate the same symmetrical key independently for network nodes. This key then encrypts and decrypts the standard IP packets passing through the IPSec tunnels. A Security Association (SA) is the outcome of an IKE negotiation.

The IKE and IPsec tunnels work in conjunction with each other. The IKE helps in establishing SA (security association) for either ESP (Encapsulated security protocol) or AH (Authentication header) which are part of IPSec protocols. The IKE is a network security protocol designed to dynamically exchange encryption keys and create Security Association (SA) between UE and evolved packet data gateway (ePDG). These security associations or SAs may be established dynamically and removed at a negotiated time period.

Conceptually, non-3GPP access may be divided into wireless versus wireline (also known as “fixed”) and may be divided into trusted versus untrusted. For untrusted non-3GPP access 300, the Internet Key Exchange (IKE) and the Internet Protocol Security (IPsec) are used between the UE and the ePDG non-3GPP Interworking Function (N3IWF) for establishing secure connectivity. For 5G untrusted non-3GPP access, Non-Access Stratum (NAS) signalling is introduced to support 5G registration and Protocol Data Unit (PDU) session setup. Between the UE and the N3IWF, the NAS signalling messages are transported through IKE message exchanges during the IKE Security Association (SA) establishment and transported through an IPsec tunnel after first IPsec SA establishment. The IKE itself does not interpret 5G NAS signalling, however, is responsible for user plane setup (IPsec tunnel establishment) between the UE and N3IWF for a PDU session.

The IP security tunnel management container 306 is further configured to perform one or more secure operations through the created at least one IP security tunnel. The one or more secure operations includes at least one of: an encryption and a decryption of the received one or more network packets. The IP security tunnel management container 306 further is configured to interact with one or more peer subsystems deployed across a plurality of peer nodes for securing the network traffic within the telecommunication network.

The IP security tunnel management container 306 is further configured to monitor the created at least one IP security tunnel to determine one or more states of the created at least one IP security tunnel and auto-restore the created at least one IP security tunnel based on the determined one or more states. In an embodiment, the IP security tunnel management container 306 monitors and self-heals IPsec tunnel state by determining if the IPsec tunnel state is going down/up due to network issue or peer node issue.

The IP security tunnel management container 306 further is configured to generate one or more alarm events corresponding to one or more northbound entities (such as for example EMS) based on the determined one or more states. In an embodiment, the IP security tunnel management container 306 is further configured to perform at least one of: enabling and disabling of the created at least one IP security tunnel based on type of network interfaces.

In an embodiment, the transport manager container 304 and the IP security tunnel management container 306 are deployed in a user plane of the base station 300.

The fast path terminating unit 308 is configured to register information related to security association database (SAD) and security policy database (SPD) from the network kernel using a network link socket. The information related to the SAD and SPD are updated by the source IKE daemon unit when the at least one IP security tunnel is created based on one or more internet key exchange (IKE) messages exchanged with the destination IKE daemon unit. In an embodiment, the fast path terminating unit 308 reads the SAD/SPD database information from the network kernel through the network link socket, such as for example, NETLINK socket. The SAD/SPD database information in the network kernel is updated by the IKE daemon unit when the IPsec tunnel is created based on the IKE messages exchanged with destination IKE daemon unit. The destination IKE daemon unit may reside within the peer node.

In an embodiment, the base station 300 may include a centralized Unit Control Plane (CU-CP) 202A, a Centralized Unit User Plane (CU-UP) 202B that is communicatively coupled to the CU-CP 202A, and a Distributed Unit (DU) 204 that is communicatively coupled to the CU-CP 202A and the CU-UP 202B. Each of the CU-CP 202A, the CU-UP 202B, and the DU 204 includes the plurality of POD subsystems 214.

The database 312 stores the information relating to the base station 300, the user equipment, the plurality of POD subsystems 214 and the like. The database 312 is, for example, a structured query language (SQL) data store. The database 312 is configured as cloud-based database implemented in the base station 300, where computing assets are delivered as a service over a cloud platform. The database 312, according to another embodiment of the present disclosure, is a location on a file system directly accessible by the plurality of POD subsystems 214. The database 312 is configured to store packet information, IKE parameters, IP Sec tunnel states, IPsec local configuration information, information associated with ciphering algorithms, one or more secret keys, one or more security policies, information on security parameter indexes (SPI), security data tables and the like. The database 312 may be a cloud database, an edge database or the like.

Those of ordinary skilled in the art will appreciate that the hardware depicted in FIG. 3 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of base stations systems suitable for use with the present disclosure is not being depicted or described herein. Instead, only so much of the base station 300 as is unique to the present disclosure or necessary for an understanding of the present disclosure is depicted and described. The remainder of the construction and operation of the base station 300 may conform to any of the various current implementation and practices known in the art.

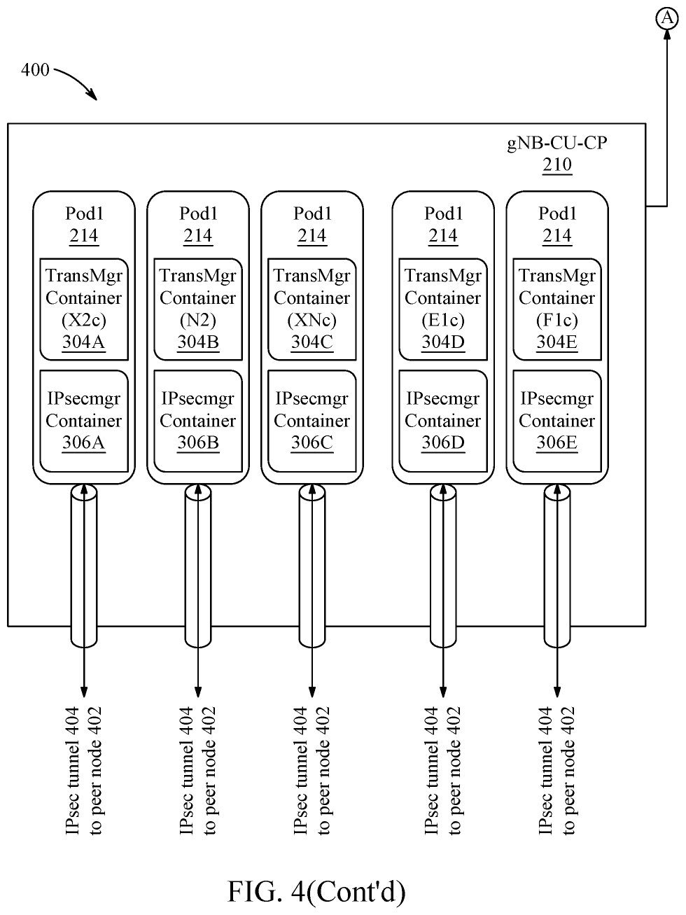

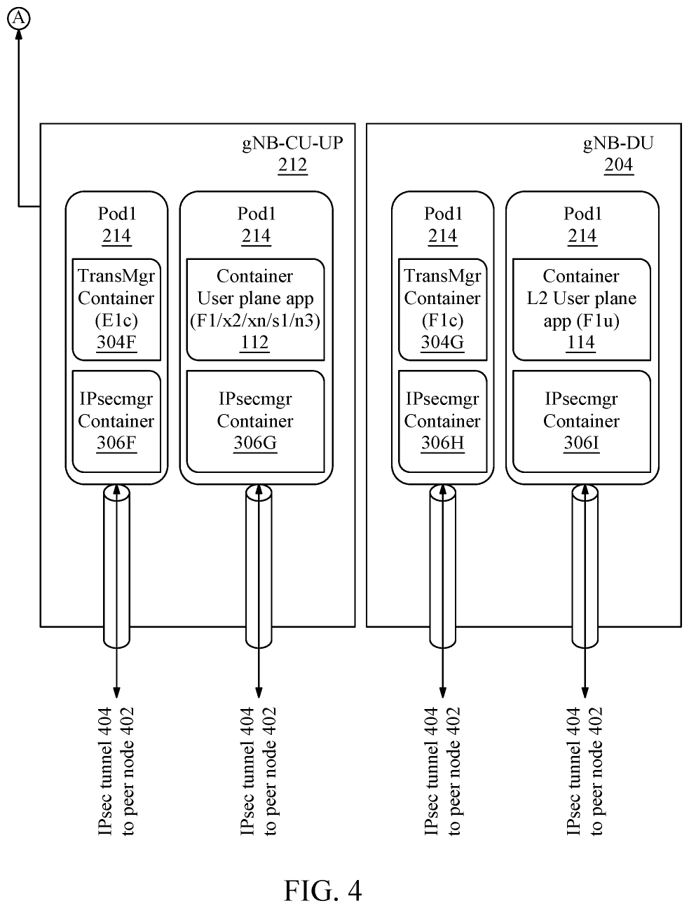

FIG. 4 is a schematic representation of 3GPP interfaces with secured network traffic using an IP security tunnel (IPsec tunnel) 404 between the plurality of POD subsystems 214 and a peer node 402, in accordance with an embodiment of the present disclosure. The IP security tunnel creation and the management functionality are integrated with each of the plurality of POD subsystems 214 as a side car service (i.e., the IP security tunnel management container 306) to secure an egress and ingress traffic for the 3GPP interfaces with the IP security, as shown in FIG. 4. The IP security tunnel management container 306 is a unified side car service designed to create and manage IPsec tunnels for gNB 3GPP interfaces (F1, E1, X2, N2, N3, S1) and across all NFs. The creation of at least one IPsec tunnel 404 between the at least one POD subsystem of the plurality of POD subsystems 214 and the peer node 402 has been explained in FIG. 3. The IP security tunnel management container 306 may be deployed for control plane interfaces (F1c, E1, X2c, XNc, N2) terminating in kernel, and/or data plane interfaces (F1u, X2u, XNu, N3, S1u) terminating in fast path application in user space (such as VPP). The IP security tunnel management container 306 may be extended to eNB 3GPP interfaces as well such as S1c, S1u, X2c, X2u, MH (Mid Haul). Further, the IP security tunnel management container 306 may control the IPsec enable/disable feature for specific interface within the plurality of POD subsystems 214. The IP security tunnel management container 306 may be extended to dynamic scaling-out or scaling-in of the PODs which needs traffic to be secured with IPsec. Furthermore, the IP security tunnel management container 306 provides a unified way of reading the IKE parameters to create and manage the tunnels across all PODs subsystems 214. Furthermore, the IP security tunnel management container 306 provides unified way of monitoring and auto restoring the IPsec tunnel if it goes down due to network issue or peer node is restarted. Also, the IP security tunnel management container 306 provides unified way of raising alarm/notification towards northbound entity (such as: EMS) whenever tunnel goes down or up. Moreover, the IP security tunnel management container 306 may be extended to other/newer PODs in RAN which needs traffic to be secured with IPsec. Additionally, the IP security tunnel management container 306 may be used for cloud based non-RAN technology PODs as well which requires its traffic to be secured.

In FIG. 4, each of gNB-CU-CP 210, gNB-CU-UP 212, and gNB-DU 204 comprises the plurality of POD subsystems 214 as microservice containers. Each of the plurality of POD subsystems 214 comprises the transport manager container 304 and the IP security tunnel management container 306. Each of these plurality of POD subsystems 214 are further connected to the peer node 402 via the IPsec Tunnel 404. The IP security tunnel management container 306 in each of these POD subsystems 214 is capable of securing the network traffic. The gNB-CU-UP 212 comprises additionally a container userplaneapp 112 (F1/x2/xn/s1/n3). The gNB-DU 204 further comprises container L2 userplaneapp (F1u) 114.

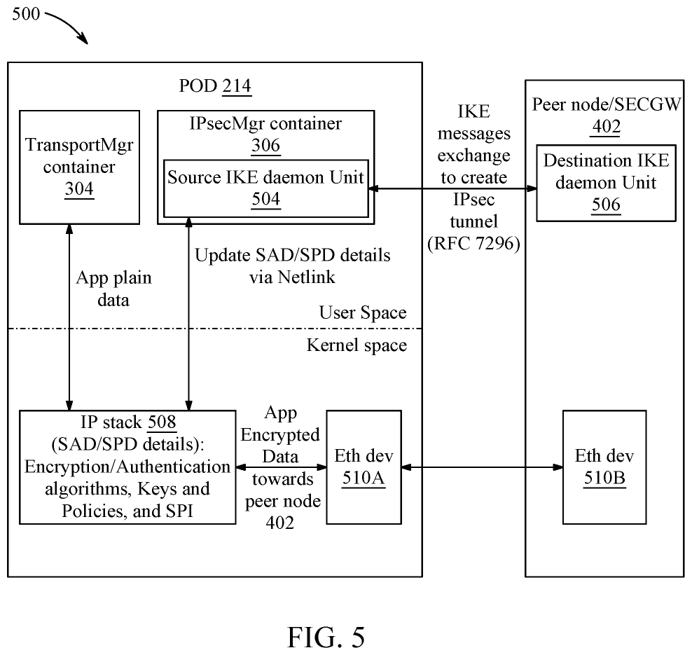

FIG. 5 is a block diagram 500 depicting a peer-to-peer communication network for creation of the IPsec tunnel 404 and crypto operations for application data, in accordance with an embodiment of the present disclosure. In FIG. 5, each POD subsystem 214 comprises the transport manager container 304 and the IP security tunnel management container 306 as described above. Additionally, the POD subsystem 214 comprises an IP stack 508 and an ethernet developer unit 510. Each of the POD subsystem 214 comprises a user space and a kernel space. The transport manager container 304 and the IP security tunnel management container 306 are deployed in the user plane. The IP security tunnel management container 306 comprises a source IKE daemon unit 504. The one or more IKE parameters are exchanged between a source IKE daemon unit 504 deployed at the base station 300 and a destination IKE daemon unit 506 deployed at the peer node 402. The source IKE daemon unit 504 is configured based on the extracted one or more IKE parameters upon successful authentication of the peer node 402.

The IP Stack 508 acts as a database for storing SAD or SPD details such as encryption/authentication algorithms, keys and policies, SPI and the like. The transport manager container 304 retrieves the application plain data from the IP stack 508. Further, the IP security tunnel management container 306 updates the SAD/SPD details in the IP Stack 508 via the NETLINK. Further, the IP Stack 508 is responsible for transmitting application encrypted data towards the peer node 402.

The peer node 402 comprises a destination IKE daemon unit 506 configured to exchange IKE messages with the source IKE daemon unit 504. The peer node 402 also comprises an ethernet developer unit 510B. In an embodiment, the peer node 402 may be another gNB or another POD subsystem or any other device.

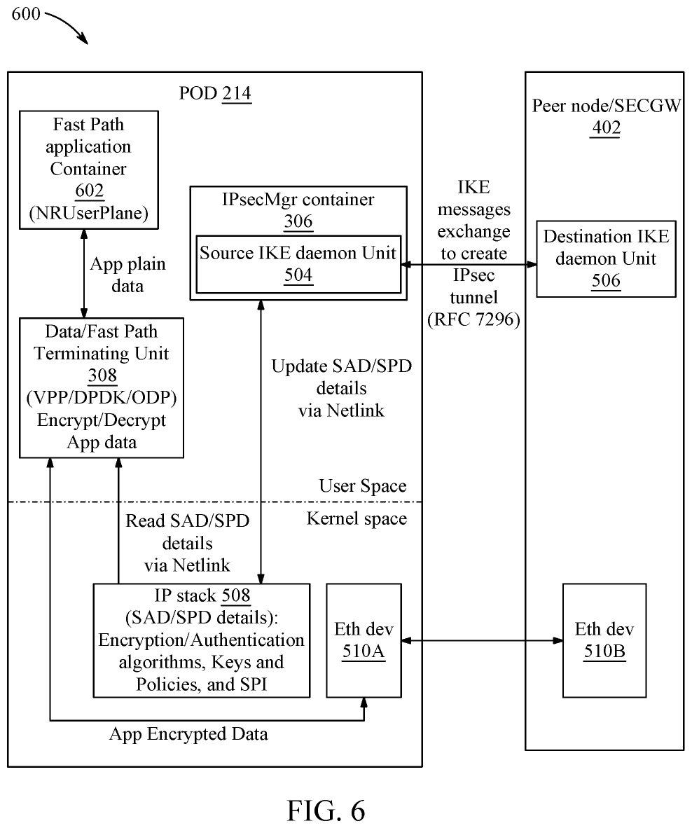

FIG. 6 is a block diagram 600 depicting the creation of the IP security tunnel 404 for fast path applications, in accordance with an embodiment of the present disclosure. FIG. 6 depicts the utilizing of the IP security tunnel management container 306 with data/fast path terminating applications including virtual pocket processing (VPP)/Open data plane (ODP) to secure a user plane traffic for the interfaces including at least one of: F1U interface, N3 interface, X2U interface, XNU interface, SIU interface, and the like. The fast path applications refer to a process in which the network packets are processed at very high rate or even close to a line rate of an ethernet interface. The transport manager container 304 and the IP security tunnel management container 306 are deployed in the user plane of the base station 300.

FIG. 6 depicts that the IP security tunnel management container 306 which exchanges the one or more IKE parameters between the source IKE daemon unit 504 deployed at the at least one POD 214 and the destination IKE daemon unit 506 deployed at the peer node 402. The IP security tunnel management container 306 updates the one or more security data tables (i.e., security association database (SAD)/security policy database (SPD) tables) in a network kernel with the set of information upon configuring the source IKE daemon unit 504. The set of information includes at least one of: information associated with ciphering algorithms, one or more secret keys, one or more security policies, information on security parameter indexes (SPI), and the like.

The fast path terminating unit 308 is configured to register information related to security association database (SAD) and security policy database (SPD) from the network kernel using a network link socket. The information related to the SAD and SPD are updated by the source IKE daemon unit 504 when the at least one IP security tunnel 404 is created based on one or more internet key exchange (IKE) messages exchanged with the destination IKE daemon unit 506. In an embodiment, the fast path terminating unit 308 reads the SAD/SPD database information from the network kernel through the network link socket, such as for example, NETLINK socket. The SAD/SPD database information in the network kernel is updated by the IKE daemon unit when the IPsec tunnel 404 is created based on the IKE messages exchanged with destination IKE daemon unit 506. The destination IKE daemon unit 506 may reside within the peer node 402.

In an embodiment, in this above fast path applications, the functionality of the IP security tunnel management container 306 is not modified to support crypto operations to be carried by the fast path terminating unit 308. The only change is needed to modify the fast path terminating unit 308 to register and read the SAD and the SPD information from the network kernel.

In an embodiment, the IP security tunnel management container 306 may be used in conjunction with data/fast path terminating application (such as VPP/ODP) to secure the user plane traffic such as F1U, N3, X2U, XNU, SIU interfaces. The fast path application is meant to process the network packets at a very high rate or even close to the line rate of the ethernet interface. As shown in FIG. 6, once the IKE messages are exchanged by IKE daemon units to create the IPsec tunnel 404, mainly following information is updated in the network kernel SAD/SPD tables by the source IKE daemon unit 504 through Netlink socket (step 2). The information includes encryption algorithm, authentication algorithm, secrete keys to encrypt/decrypt the network packets, SPI (Security parameter Index) and the like. The above same SAD and SPD information needs be read by the fast path terminating application (such as VPP/ODP) through the Net link socket. Then, this information is used to encrypt or decrypt the network packets originated from/to application (such as NR user plane).

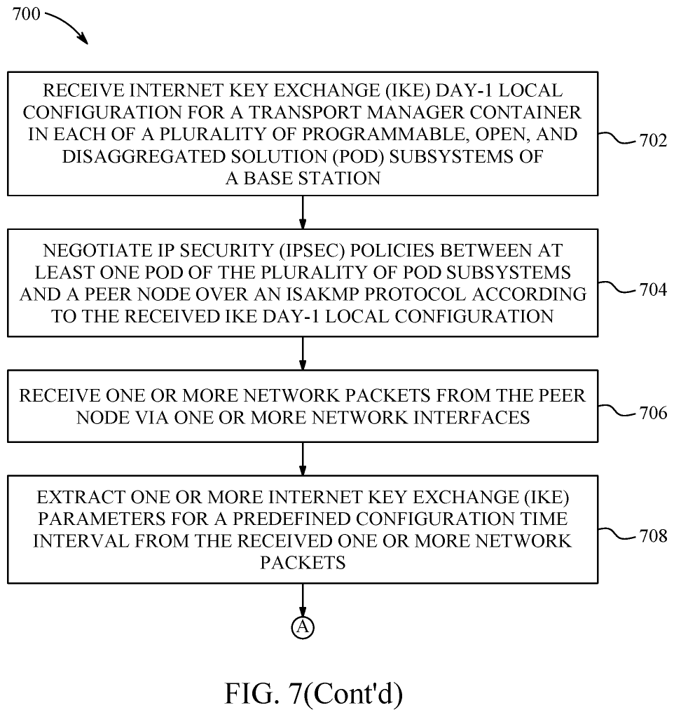

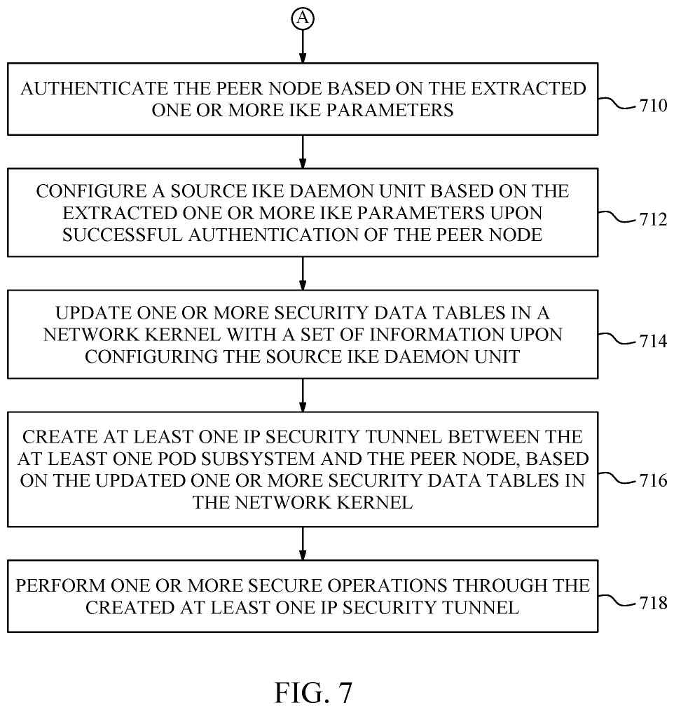

FIG. 7 is a flowchart illustrating a computer implemented method 700 for securing the network traffic using the IP security tunnels 404 in the telecommunication network, in accordance with an embodiment of the present disclosure. At step 702, the Internet Key Exchange (IKE) day−1 local configuration is received for the transport manager container 304 in each of the plurality of Programmable, Open, and Disaggregated Solution (POD) subsystems 214 of the base station 300.

At step 704, the IP security (IPsec) policies are negotiated between at least one POD of the plurality of POD subsystems 214 and the peer node 402 over an ISAKMP protocol according to the received IKE day−1 local configuration.

At step 706, the one or more network packets are received from the peer node 402 via one or more network interfaces. In an embodiment, the peer node 402 is communicatively connected to at least one POD subsystem of the plurality of POD subsystems 214 of the base station 300.

At step 708, one or more internet key exchange (IKE) is extracted for the predefined configuration time interval from the received one or more network packets. The one or more IKE parameters are exchanged between the source IKE daemon unit 504 deployed at the base station 300 and the destination IKE daemon unit 506 deployed at the peer node 402.

At step 710, the peer node is authenticated based on the extracted one or more IKE parameters.

At step 712, the source IKE daemon unit 504 is configured based on the extracted one or more IKE parameters upon successful authentication of the peer node 402.

At step 714, the one or more security data tables in the network kernel are updated with the set of information upon configuring the source IKE daemon unit 504. The set of information includes at least one of: the information associated with the ciphering algorithms, the one or more secret keys, the one or more security policies, the information on the security parameter indexes (SPI), and the like.

At step 716, the at least one IP security tunnel 404 is created between the at least one POD subsystem 214 and the peer node 402, based on the updated one or more security data tables in the network kernel.

At step 718, the one or more secure operations are performed through the created at least one IP security tunnel 404. The one or more secure operations includes at least one of: the encryption and the decryption of the received one or more network packets.

In an embodiment, the at least one IP security tunnel 404 is monitored to determine the one or more states of the created at least one IP security tunnel 404. The created at least one IP security tunnel 404 is auto restored based on the determined one or more states. Further, the one or more alarm events are generated corresponding to one or more northbound entities based on the determined one or more states. In an embodiment, the peer node 402 is authenticated based on the extracted one or more IKE parameters by retrieving the device certificate information of the peer node 402 from the extracted IKE parameters and authenticating the peer node 402 based on the retrieved device certificate information.

The present disclosure provides the IP security tunnel management container 306 that is used as a common service to secure the traffic for each of the gNB 3GPP interfaces namely F1, E1, X2, N2, N3, S1 interfaces. The IP security tunnel management container 306 acts as a plug and play module that is easy to integrate the solution and hence faster development time. Further, the present disclosure is easy to extend the solution to additional POD subsystems 214 in the RAN other than above said interfaces such as F1, E1, X2, N2, N3, S1 to secure its traffic with IP security. The present disclosure does not require redundant code and hence easy to maintain the POD subsystems 214.

The present disclosure utilizes the same IP security tunnel management container 306 for control path and data/fast path interfaces in same/different POD subsystems 214, wherein the control path interfaces generally terminated in kernel and the data/fast path interfaces generally terminated in user space by a fast path application like VPP. The present disclosure is a generic solution, which may be used for cloud based non-RAN technology PODs as well to secure its traffic. Further, the present disclosure reduces the overall development time. The present disclosure utilizes the IP security tunnel management container 306 to monitor and auto-restore the created IPsec tunnel 404 whenever it goes up and down due to the network issue and restarting of the peer node 402.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer readable medium may be any apparatus that can comprise, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, and the like.) may be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at-least one processor or central processing unit (CPU). The CPUs are interconnected via system bus 310 to various devices such as a random-access memory (RAM), read-only memory (ROM), and an input/output (I/O) adapter. The I/O adapter may connect to peripheral devices, such as disk units and tape drives, or other program storage devices that are readable by the system. The system may read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like. of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A base station for securing network traffic using Internet Protocol Security (IPSec) tunnels in a telecommunication network, the base station comprising:
one or more hardware processors; and
a memory coupled to the one or more hardware processors, wherein the memory comprises a plurality of Programmable, Open, and Disaggregated Solution (POD) subsystems in a form of microservice based containers executable by the one or more hardware processors, wherein each of the plurality of POD subsystems comprises:
a transport manager container configured to handle network traffic terminations of one or more network interfaces, wherein the one or more network interfaces comprises at least one of: a control path interface and data path interface; and
an internet protocol (IP) security tunnel management container communicatively coupled to the transport manager container, wherein the IP security tunnel management container is configured to:
receive Internet Key Exchange (IKE) day−1 local configuration for each transport manager container in each of the plurality of POD subsystems;
negotiate IPsec policies with a peer node over an ISAKMP protocol according to the received IKE day−1 local configuration;
receive one or more network packets from the peer node via the one or more network interfaces, wherein the peer node is communicatively connected to at least one POD subsystem of the plurality of POD subsystems of the base station;
extract one or more IKE parameters for a predefined configuration time interval from the received one or more network packets, wherein the one or more IKE parameters are exchanged between a source IKE daemon unit deployed at the at least one POD and a destination IKE daemon unit deployed at the peer node;
authenticate the peer node based on the extracted one or more IKE parameters;
configure the source IKE daemon unit based on the extracted one or more IKE parameters upon successful authentication of the peer node;
update one or more security data tables in a network kernel with a set of information upon configuring the source IKE daemon unit, wherein the set of information comprises at least one of: information associated with ciphering algorithms, one or more secret keys, one or more security policies, and information on security parameter indexes (SPI);
create at least one IP security tunnel between the at least one POD and the peer node, based on the updated one or more security data tables in the network kernel; and
perform one or more secure operations through the created at least one IP security tunnel, wherein the one or more secure operations comprises at least one of: an encryption and a decryption of the received one or more network packets.

2. The base station of claim 1, wherein the IP security tunnel management container is further configured to:
monitor the created at least one IP security tunnel to determine one or more states of the created at least one IP security tunnel; and
auto-restore the created at least one IP security tunnel based on the determined one or more states.

3. The base station of claim 2, wherein the IP security tunnel management container is further configured to:
generate one or more alarm events corresponding to one or more northbound entities based on the determined one or more states.

4. The base station of claim 1, wherein the transport manager container and the IP security tunnel management container are deployed in a user plane of the base station.

5. The base station of claim 1, wherein the one or more IKE parameters comprise an IP address of the peer node, one or more ciphering algorithms, security policy details, and a peer node certificate identifier.

6. The base station of claim 4, further comprising a fast path terminating unit configured to register information related to security association database (SAD) and security policy database (SPD) from the network kernel using a network link socket, wherein the information related to the SAD and SPD are updated by the source IKE daemon unit when the at least one IP security tunnel is created based on one or more internet key exchange (IKE) messages exchanged with the destination IKE daemon unit.

7. The base station of claim 1, wherein the IP security tunnel management container is further configured to perform at least one of: enabling and disabling of the created at least one IP security tunnel based on type of network interfaces.

8. The base station of claim 1, wherein in authenticating the peer node based on the extracted one or more IKE parameters, the IP security tunnel management container is configured to:
retrieve device certificate information of the peer node from the extracted IKE parameters; and
authenticate the peer node based on the retrieved device certificate information.

9. The base station of claim 1, wherein the IP security tunnel management container is configured to:
interact with one or more peer subsystems deployed across plurality of peer nodes for securing the network traffic within the telecommunication network.

10. The base station of claim 1, further comprising:
a Centralized Unit Control Plane (CU-CP);
a Centralized Unit User Plane (CU-UP) communicatively coupled to the CU-CP; and
a Distributed Unit (DU) communicatively coupled to the CU-CP and the CU-UP, wherein each of the CU-CP, the CU-UP, and the DU comprises the plurality of POD subsystems.

11. A method for securing network traffic using Internet Protocol Security (IPSec) tunnels in a telecommunication network, the method comprising:
receiving, by a processor, an Internet Key Exchange (IKE) day−1 local configuration for a transport manager container in each of a plurality of Programmable, Open, and Disaggregated Solution (POD) subsystems of a base station;
negotiating, by the processor, internet security (IPsec) policies between at least one POD of the plurality of POD subsystems and a peer node over an ISAKMP protocol according to the received IKE day−1 local configuration;
receiving, by the processor, one or more network packets from the peer node via one or more network interfaces, wherein the peer node is communicatively connected to at least one POD subsystem of the plurality of POD subsystems of the base station;
extracting, by the processor, one or more internet key exchange (IKE) parameters for a predefined configuration time interval from the received one or more network packets, wherein the one or more IKE parameters are exchanged between a source IKE daemon unit deployed at the base station and a destination IKE daemon unit deployed at the peer node;
authenticating, by the processor, the peer node based on the extracted one or more IKE parameters;
configuring, by the processor, the source IKE daemon unit based on the extracted one or more IKE parameters upon successful authentication of the peer node;
updating, by the processor, one or more security data tables in a network kernel with a set of information upon configuring the source IKE daemon unit, wherein the set of information comprises at least one of: information associated with ciphering algorithms, one or more secret keys, one or more security policies, and information on a security parameter indexes (SPI);
creating, by the processor, at least one IP security tunnel between the at least one POD subsystem and the peer node, based on the updated one or more security data tables in the network kernel; and
performing, by the processor, one or more secure operations through the created at least one IP security tunnel, wherein the one or more secure operations comprises at least one of: an encryption and a decryption of the received one or more network packets.

12. The method of claim 11, further comprising:
monitoring the created at least one IP security tunnel to determine one or more states of the created at least one IP security tunnel; and
auto restoring the created at least one IP security tunnel based on the determined one or more states.

13. The method of claim 12, further comprising:
generating one or more alarm events corresponding to one or more northbound entities based on the determined one or more states.

14. The method of claim 11, wherein the one or more IKE parameters comprise an internet protocol (IP) address of the peer node, one or more ciphering algorithms, security policy details, and a peer node certificate identifier.

15. The method of claim 11, further comprising:
registering information related to security association database (SAD) and security policy database (SPD) from the network kernel using a network link socket, wherein the information related to the SAD and SPD are updated by the source IKE daemon unit when the at least one IP security tunnel is created based on one or more internet key exchange (IKE) messages exchanged with the destination IKE daemon unit.

16. The method of claim 11, further comprising performing at least one of: enabling and disabling of the created at least one IP security tunnel based on type of network interfaces.

17. The method of claim 11, wherein authenticating the peer node based on the extracted one or more IKE parameters comprises:
retrieving device certificate information of the peer node from the extracted IKE parameters; and
authenticating the peer node based on the retrieved device certificate information.

18. The method of claim 11, further comprising:
interacting with one or more peer subsystems deployed across plurality of peer nodes for securing the network traffic within the telecommunication network.

19. A non-transitory computer-readable storage medium having instructions stored therein that when executed by a hardware processor, cause the processor to execute operations of:
receiving Internet Key Exchange (IKE) day−1 local configuration for a transport manager container in each of a plurality of Programmable, Open, and Disaggregated Solution (POD) subsystems of a base station;
negotiating Internet Protocol Security (IPSec) policies between at least one POD of the plurality of POD subsystems and a peer node over an ISAKMP protocol according to the received IKE day−1 local configuration;
receiving one or more network packets from a peer node via one or more network interfaces, wherein the peer node is communicatively connected to at least one POD subsystems of a plurality of POD subsystems of a base station;
extracting one or more IKE parameters for a predefined configuration time interval from the received one or more network packets, wherein the one or more IKE parameters are exchanged between a source IKE daemon unit deployed at the base station and a destination IKE daemon unit deployed at the peer node;
authenticating the peer node based on the extracted one or more IKE parameters;
configuring the source IKE daemon unit based on the extracted one or more IKE parameters upon successful authentication of the peer node;
updating one or more security data tables in a network kernel with a set of information upon configuring the source IKE daemon unit, wherein the set of information comprises at least one of: information associated with ciphering algorithms, one or more secret keys, one or more security policies, and information on a security parameter indexes (SPI);
creating at least one IP security tunnel between the at least one POD subsystem and the peer node, based on the updated one or more security data tables in the network kernel; and
performing one or more secure operations through the created at least one IP security tunnel, wherein the one or more secure operations comprises at least one of: an encryption and a decryption of the received one or more network packets.

20. The non-transitory computer-readable storage medium of claim 19, further comprising instructions to cause the processor to perform:
monitoring the created at least one IP security tunnel to determine one or more states of the created at least one IP security tunnel; and
auto restoring the created at least one IP security tunnel based on the determined one or more states.
